(19) United States
(12) Patent Application Publication
(10) Pub. No.: US 2025/0307375 A1
(43) Pub. Date: Oct. 2, 2025

(54) GO-STOP SMART VALVE STATION

(71) Applicant: SAUDI ARABIAN OIL COMPANY, Dhahran (SA)

(72) Inventors: Mohammed N. Almannai, Dhahran (SA); Abdullah A. Aljindan, Dammam (SA); Saad A. Alwuhaib, Dhahran (SA)

(73) Assignee: SAUDI ARABIAN OIL COMPANY, Dhahran (SA)

(21) Appl. No.: 18/624,678

(22) Filed: Apr. 2, 2024

(51) Int. Cl. G06F 21/44; E21B 34/06; F16K 35/00

(52) U.S. Cl. CPC G06F 21/44; E21B 34/066; F16K 35/00

(57) ABSTRACT

A method and a system are disclosed. The method includes including obtaining a first request to operate a first go-stop (G-S) smart valve in a well by a first user, wherein the first request is transmitted to a system manager in response to a user input of a first user credential to a first system device. The method further includes determining that the first user associated with the first user credential is authorized to operate the first G-S smart valve at the well and transmitting a command to the first G-S smart valve, wherein the command grants authorization to the first user to operate the first G-S smart valve. An operational status of the first G-S smart valve is indicated based on the determination and an access to the well is controlled based on the operational status of the first G-S smart valve.

### BACKGROUND

Oil and gas production systems produce hydrocarbons and water from production wells. Production wells and systems have safety systems to prevent and isolate potential hazards while drilling and production operations. If potential hazards are not prevented, dangerous situations may arise that result in equipment damage and injury or death of people in the vicinity. The dangerous situations may also result in the release of production and operation fluids, such as oil, that may result in the contamination of the environment.

Integration of flow control devices, particularly valves, plays an important role in controlling fluid dynamics. The valves regulate the flow of hydrocarbons and other substances with precision. However, to ensure operational efficacy and safety, user authorization may be required. This proactive approach ensures that only authorized personnel, equipped with the requisite skills and understanding, can operate the valves, thereby fortifying the well system against potential hazards.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

Embodiments disclosed herein generally relate to a method, the method including obtaining a first request to operate a first go-stop (G-S) smart valve in a well by a first user, wherein the first request is transmitted to a system manager in response to a user input of a first user credential to a first system device. The method further includes determining that the first user associated with the first user credential is authorized to operate the first G-S smart valve at the well and transmitting a command to the first G-S smart valve, wherein the command grants authorization to the first user to operate the first G-S smart valve. An operational status of the first G-S smart valve is indicated based on the determination and an access to the well is controlled based on the operational status of the first G-S smart valve.

Embodiments disclosed herein generally relate to a system. The system includes a plurality of control systems at a well comprising a wellbore and a first system device. The system further includes a system manager comprising a computer processor and coupled to the plurality of control systems and the first system device. The computer processor includes functionality for obtaining a first request to operate a first go-stop (G-S) smart valve in the well by a first user, wherein the first request is transmitted to a system manager in response to a user input of a first user credential to a first system device. Further, the first user associated with the first user credential is determined to be authorized to operate the first G-S smart valve at the well and a command to the first G-S smart valve is transmitted, wherein the command grants authorization to the first user to operate the first G-S smart valve. Additionally, an operational status of the first G-S smart valve is indicated based on the determination and an access to the well is controlled based on the operational status of the first G-S smart valve.

Embodiments disclosed herein generally relate to a non-transitory computer readable medium storing instructions executable by a computer processor. The instructions include functionality for obtaining a first request to operate a first go-stop (G-S) smart valve in the well by a first user, wherein the first request is transmitted to a system manager in response to a user input of a first user credential to a first system device. Further, the first user associated with the first user credential is determined to be authorized to operate the first G-S smart valve at the well and a command to the first G-S smart valve is transmitted, wherein the command grants authorization to the first user to operate the first G-S smart valve. Additionally, an operational status of the first G-S smart valve is indicated based on the determination and an access to the well is controlled based on the operational status of the first G-S smart valve.

Other aspects and advantages of the claimed subject matter will be apparent from the following description and the appended claims.

### BRIEF DESCRIPTION OF DRAWINGS

Specific embodiments of the disclosed technology will now be described in detail with reference to the accompanying figures. Like elements in the various figures are denoted by like reference numerals for consistency.

FIG. 1 shows a system in accordance with one or more embodiments.

FIG. 2 shows a valve system in accordance with one or more embodiments.

FIG. 3 shows a G-S smart valve schematic in accordance with one or more embodiments.

FIG. 4 shows an exemplary interaction between a user and a system in accordance with one or more embodiments.

FIG. 5 shows a flowchart in accordance with one or more embodiments.

FIG. 6 shows a computer system in accordance with one or more embodiments.

### DETAILED DESCRIPTION

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as using the terms “before,” “after,” “single,” and other such terminology. Rather, the use of ordinal numbers is to distinguish between the elements. By way of an example, a first element is distinct from a second element, and the first element may encompass more than one element and succeed (or precede) the second element in an ordering of elements.

It is to be understood that the singular forms “a,” “an,” and “the” include plural referents unless the context clearly dictates otherwise.

Terms such as “approximately,” “substantially,” etc., mean that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

It is to be understood that one or more of the steps shown in the flowchart may be omitted, repeated, and/or performed in a different order than the order shown. Accordingly, the scope disclosed herein should not be considered limited to the specific arrangement of steps shown in the flowchart.

Although multiple dependent claims are not introduced, it would be apparent to one of ordinary skill that the subject matter of the dependent claims of one or more embodiments may be combined with other dependent claims.

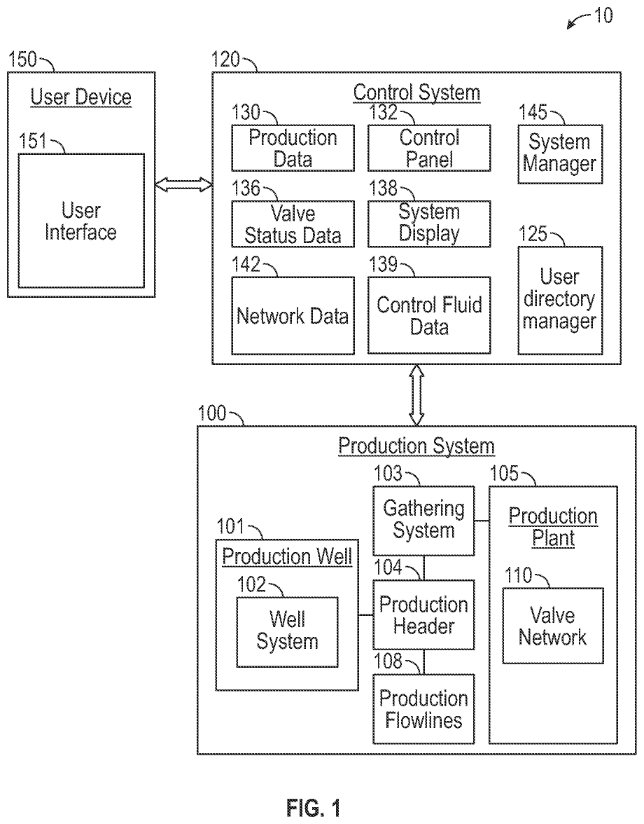

In the following description of FIGS. 1-6, any component described with regard to a figure, in various embodiments disclosed herein, may be equivalent to one or more like-named components described with regard to any other figure. For brevity, descriptions of these components will not be repeated with regard to each figure. Thus, each and every embodiment of the components of each figure is incorporated by reference and assumed to be optionally present within every other figure having one or more like-named components. Additionally, in accordance with various embodiments disclosed herein, any description of the components of a figure is to be interpreted as an optional embodiment which may be implemented in addition to, in conjunction with, or in place of the embodiments described with regard to a corresponding like-named component in any other figure.

Disclosed herein are methods and systems of using a Go-Stop (G-S) smart valve in a valve network. The present invention may include production systems with production wells configured to produce production fluids such as oil, condensate, gas, and/or water. Production systems may include gathering systems for the production fluids that may gather production fluids from many production wells. Production fluids may flow to a production plant for processing. The production plant may include safety systems such as valve networks to prevent potential hazards during drilling and production operations. Valve networks operate utilizing valves and valve systems. Valve networks may include valves configured to be automated such as automated G-S smart valve.

The G-S valve indicates whether any given well may be operated when a green light is present or cannot be operated when a red light is present. Such practice allows any individual who is planning to interact with the well to view the status of that well (e.g., Go or Stop), eliminating any safety implications that may result from operating a well that should not be operated on. Additionally, the G-S smart valve station may utilize a card scanner on an operated G-S smart valve, if an operator intends to open any given well, the individual's company ID may be placed against the card scanner to record the event of closing and opening by the operator with high accuracy. Specifically, recording the event of closing and opening the G-S smart valve by the operator enables to remotely determine the operational status of the well. To enable any given individual to actively open and close the smart G-S smart valve stations, approval to the same operator has to be granted by the production engineer, plant engineer, shift coordinator, system manager, or any other assigned person with certain privileges. The remote determination of the operational status of the well enhances the compliance of any given well and provides an accurate reflection of desired operational status in accordance with assigned objectives and targets.

The G-S smart valve system accurately showcases the well's live status. More specifically, whether the well is open or closed, without the need to allocate the resources for a field representative to go to the field and confirm the state of the well. Applying the G-S smart valve system would additionally enable the determination of an operator who last operated the well and executed an action. That would remotely provide an accurate status of the well and help in planning, identifying root causes and achieving compliance with long-term strategic production and/or injection objectives.

Additionally, the G-S smart valve system provides an additional safety barrier that may be utilized to isolate the well. The safety aspects of the G-S smart valve system are numerous, and the G-S smart valve system may stop a variety of safety implications by the simple logic of representing the well's readiness as a visual indication in terms of two color indications, green or red. For example, when the operator arrives at the well location and is planning to operate a well with a downhole casing leak and the G-S smart valve stations are indicating red, the operator should refrain from operating the well. Such action prevents a well control issue from occurring or returning. Additionally, the simple logic of representing the well's readiness may also be a digital indication in terms of on and off status that is transmitted to a control system.

In one or more embodiments, the benefits of the G-S smart valve system include making it easy to identify whether the well may be operated by field operation representatives. Additionally, all events related to the opening and closing status of any well-equipped G-S smart valve system are recorded, ensuring that compliance with set production targets is achieved and maintained. Further, the G-S smart valve system provides a mechanism for identifying the live operational status of the well remotely, with records of each operational status change.

Additionally, the G-S smart valve system provides a security measure by controlling the access to the well using authentication of the operator's credentials. Such safety measures provided by the G-S smart valve system provide an additional safety barrier and improve the integrity of the well. The G-S smart valve system is located far from the wellhead and allows easier access in case of an emergency. Further, by utilizing G-S smart valve station, wells will be compliant to their set production/injection modes (e.g., on and off). Additionally, wells that are facing well integrity related problems will not be unintentionally operated, thus, ensuring safety and reliability of company's assets.

For exemplary purposes, consider a scenario in which a well is secured via kill valve and plug and a field representative attends the well with no knowledge of that and opens the well for production and/or injection, the securement and integrity of the well would be compromised. However, the well integrity issue and associated expenses with killing and securing the well would be eliminated using the G-S smart valve. In addition, the application of the G-S smart valve provides significant revenue generation in terms of effectively controlling well compliance and achieving recovery targets from any given reservoir and applying the set strategy for that reservoir accurately. Further, the G-S smart valve ensures reaping the full financial benefits associated with the reservoir strategic plan and avoiding unnecessary recovery challenges associated with in-compliance overall.

In one or more embodiments, the G-S smart valve may be a surface-based valve that may be functional and log operational values during a drilling phase, a workover phase, and even during normal operating conditions without a rig on well location. The G-S smart valve capabilities arise due to its independent nature away from the wellhead and well location. The functionality of the G-S smart valve station does not depend on the existence of a rig on location to provide a tangible value nor an intervention situation, but always provides value by ensuring at all times that the well is disconnected from the Gas Oil Separation Plant (GOSP) or Water Injection Plant (WIP). Further, a G-S smart valve is an independent valve station that does not affect the functionality of any given wellhead valve and does not pose an integrity compromise as a result.

In one or more embodiments, the G-S smart valve also provides real-time operational status of the well by close follow-up of the latest event of closing and/or opening the well through a card scanning process. That enables one to remotely view the status of the well and ensure wells meant to be closed are closed, and well meant to be opened are opened. Additionally, the Green/Red Go-Stop light system in the valve stations provides a live operational status also for any individual who is visiting the well to accurately know if the well is operable or not.

FIG. 1 shows a schematic diagram of a G-S smart valve station in accordance with one or more embodiments. As shown in FIG. 1, the G-S smart valve station is a system of go-stop for smart valves (hereafter “G-S smart valve system”) (10) may include a production system (100), a user device (150), a control system (120), a valve network (110) and various network elements (not shown). In other words, the G-S smart valve station is a valve itself. There may be multiple G-S valves in one G-S smart valve system. In some embodiments, the production system (100) may include a production well (101), a gathering system (103), and a production plant (105). In one or more embodiments, the control system (120) may be a production plant server. In some embodiments, various types of production data (130) are collected over the G-S smart valve system (10). Likewise, the G-S smart valve system (10) may also obtain valve status data (136) regarding one or more G-S smart valves throughout the G-S smart valve system (10). The G-S smart valve system (10) may be configured to utilize control fluids such as, but not limited to, air, gas, hydraulic fluid, or other fluids for operating. The G-S smart valve system (10) may also obtain control fluid data (139) such as, but not limited to, pressure, temperature, and/or control fluid composition. Even though FIG. 1 shows only one valve network, it will be obvious to one skilled in the art that the G-S smart valve system may include more than one valve network.

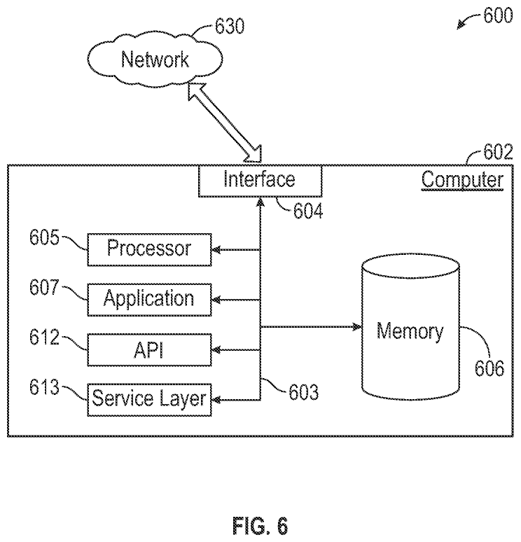

Furthermore, the production well (101) may include a well system (102) located in a well environment that includes a hydrocarbon reservoir (“reservoir”) located in a subsurface hydrocarbon-bearing formation. The hydrocarbon-bearing formation may include a porous or fractured rock formation that resides underground, beneath the earth's surface (“surface”). In the case of the well system (102) being a hydrocarbon well, the reservoir may include a portion of the hydrocarbon-bearing formation. The hydrocarbon-bearing formation and the reservoir may include different layers of rock having varying characteristics, such as varying degrees of permeability, porosity, and resistivity. In the case of the well system (102) being operated as a hydrocarbon well, the well system (102) may facilitate the extraction of hydrocarbons (or “production”) from the reservoir. In some embodiments, the well system (102) includes a wellbore, a well sub-surface system, a well surface system, and a well operating system. The wellbore may include a bored hole that extends from the surface into a target zone of the hydrocarbon-bearing formation, such as the reservoir. The wellbore may facilitate the circulation of drilling fluids during drilling operations, the flow of hydrocarbon production (“production”) (e.g., oil and gas) from the reservoir to the surface during production operations, the injection of substances (e.g., water) into the hydrocarbon-bearing formation or the reservoir during injection operations, or the communication of monitoring devices (e.g., logging tools) into the hydrocarbon-bearing formation or the reservoir during monitoring operations (e.g., during in situ logging operations). A well operating system in the well system (102) may control various operations of the well system (102), such as well production operations, well completion operations, well maintenance operations, and reservoir monitoring, assessment, and development operations. In some embodiments, the well operating system includes a computer system (600) that is the same as or similar to that of a computer (602) described below in FIG. 6 and the accompanying description.

In some embodiments, one or more production wells are coupled to the gathering system (103). The gathering system (also referred to as a collecting system or gathering facility) (103) may include various hardware arrangements and pipe components that connect one or more production flowlines (108) from several production wells into a single gathering line. For example, a gathering system may include flowline networks, headers, pumping facilities, separators, emulsion treaters, compressors, dehydrators, tanks, valves, regulators, and/or associated equipment. In particular, a production header (104) may have production valves and testing valves to control a mixed stream for a flowline of a respective production well. Thus, a gathering system may direct various hydrocarbon fluids to a processing or testing facility, such as a production plant. In some embodiments, a gathering system manages individual fluid ratios (e.g., a particular gas-to-water ratio or condensate-to-gas ratio) as well as supply rates of oil, gas, and water. For example, a gathering system may assign a particular production value or ratio value to a particular production well by opening and closing selected valves among the production headers and using individual metering equipment or separators. Furthermore, a gathering system may be a radial system or a trunk line system. A radial system may bring various flowlines to a single central header. In contrast, a trunk-line system may use several production headers to collect oil and gas from fields that cover a large geographic area. Once collected, a gathering system may transport and control the flow of oil or gas to a storage facility, a production processing plant, or a shipping point.

Keeping with FIG. 1, production may be transported from one or more production wells to one or more production plants. More specifically, a production plant may refer to various types of industrial plants such as a production processing plant, a production cycling plant, or a compressor plant. A production processing plant (also referred to as a natural gas processing plant) may be a facility that processes natural gas to recover natural gas liquids (e.g., condensate, natural gasoline, and liquefied petroleum gas) and sometimes other substances such as sulfur. A production cycling plant may refer to an oilfield installation coupled with a gas-condensate reservoir. In particular, a production cycling plant may extract various liquids from natural gas. Consequently, the remaining dry gas may be compressed prior to returning to a producing formation, e.g., to maintain reservoir pressure. Moreover, various components of natural gas may be classified according to their vapor pressures, such as low-pressure liquid (i.e., condensate), intermediate-pressure liquid (i.e., natural gasoline), and high-pressure liquid (i.e., liquefied petroleum gas). Examples of natural gas liquids include propane, butane, pentane, hexane, and heptane. With respect to compressor plants, a compressor plant may be a facility that includes multiple gas compressors, auxiliary treatment equipment, and pipeline installations for pumping natural gas over long distances. A compressor station may also repressurize gas in large gas pipelines or link offshore gas fields to their final terminals.

In some embodiments, the production plant (105) may include one or more pipe components, one or more storage facilities, and one or more control systems. For example, different forms of production fluids may be stored in various storage facilities that include surface containers as well as various underground reservoirs, such as depleted production fluid reservoirs, aquifer reservoirs, and salt cavern reservoirs. With respect to control systems, the control system (120) may include hardware and/or software that monitors and/or operates equipment, such as at a production well or in a production plant. Examples of control systems may include one or more of the following: an emergency shutdown (ESD) system, a safety control system, a vibration monitoring system (VMS), process analyzers, other industrial systems, etc. In particular, the control system (120) may include a programmable logic controller that may control valve states, fluid levels, pipe pressures, warning alarms, pressure releases, and/or various hardware components for implementing a production flowline. Thus, a programmable logic controller may be a ruggedized computer system with the functionality to withstand vibrations, extreme temperatures, wet conditions, and/or dusty conditions, such as those around a production plant, a production well, and/or a gathering system.

With respect to distributed control systems, a distributed control system may be a computer system for managing various processes at a facility using multiple control loops. As such, a distributed control system may include various autonomous controllers (such as remote terminal units (RTUs)) positioned at different locations throughout the facility to manage operations and monitor processes. Likewise, a distributed control system may include no single centralized computer for managing control loops and other operations. On the other hand, a SCADA system may include a control system that includes functionality for enabling monitoring and issuing of process commands through local control at a facility as well as remote control outside the facility. With respect to an RTU, an RTU may include hardware and/or software, such as a microprocessor, that connects sensors and/or actuators using network connections to perform various processes in the automation system.

Keeping with control systems, the control system (120) may be operatively connected to the facility equipment of the production system (100). Facility equipment may include various machinery such as one or more hardware components, such as pipe components, refrigeration system components, and/or electrical system components, that may be monitored using one or more sensors. Examples of hardware components operatively connected to the control system (120) may include crude oil preheaters, heat exchangers, pumps, valves, compressors, loading racks, and storage tanks among various other types of hardware components. Hardware components may also include various network elements or control elements for implementing control systems, such as switches, sensors, routers, hubs, PLCs, remote terminal units, user equipment, or any other technical components for performing specialized processes. Examples of sensors may include pressure sensors, flow rate sensors, temperature sensors, torque sensors, rotary switches, limit feedback switches, electrical sensors, weight sensors, position sensors, microswitches, hydrophones, accelerometers, etc. Sensors may be configured to detect component malfunctions and are operatively connected to control systems. Control systems, user devices, and network elements may be computer systems similar to the computer system (600) described in FIG. 6 and the accompanying description.

In some embodiments, the control system (120) may include hardware and/or software for collecting data in real-time from various gas wells, gas plants, sensors coupled to hardware equipment and pipe components, user devices, and other systems (e.g., electrical, alarm) in the G-S smart valve system (10). For example, the control system (120) may be one or more plant servers with functionality for obtaining data throughout the G-S smart valve system (10), such as production data (130), and valve system data (e.g., valve status data (136). For example, production data (130) may include operating upstream and downstream sensor data for various pipe components (e.g., pressure data, temperature measurements, and gas flow rates), and production flow rates from various pipeline information (PI) systems, such as control systems located throughout the G-S smart valve system (10). Production data (130) may also include production fluid chemical composition data, such as condensate-gas ratio (CGR) data, and water sampling data (e.g., levels of Chloride and Strontium concentrations). Likewise, production data (130) may also include material and design specifications for various production components that form production flowlines, such as pipe component geometry and pipe component compositions. The control system (120) may also collect various production parameters regarding production plant operations, production well operations, and production header information regarding the gathering system (103) coupled to the production wells.

In some embodiments, the control system (120) may include a control panel (132) configured to control all the systems of the G-S smart valve system (10). The control panel (132) may be operatively connected to all the systems of the production system (100) and one or more valve networks. The control panel (132) may include hardware equipment and/or software for transmitting commands to the various systems. The control panel (132) may include a computer (602) as described in FIG. 6 and the accompanying description.

In some embodiments, the control system (120) may include a system manager (145). In some embodiments, a system manager (145) may be a software-defined controller or a hardware controller that includes hardware and/or software for collecting well operation data, valve data, reservoir pressure. Well operation data may describe one or more well operations being perform at a well site, such as drilling operation data, well completion data, well stimulation data, flowback data, etc. Valve data may describe the state of one or more valves in a well network, such as which valves are open, which valves are closed, which valves have fluid passing through them, and condition data regarding the valves (e.g., degree of erosion, valve temperature, valve pressure, valve history, etc.). Reservoir pressure data may describe pressure conditions downhole in a well, such as high pressure conditions during a flowback operation. In some embodiments, the system manager (145) may include a computer system that is similar to the computer system (600) described below with regard to FIG. 6 and the accompanying description. Likewise, the system manager (145) may be a cloud server located remotely from a well site.

In some embodiments, a system manager (145) may be integrated with one or more user interfaces (151) to monitor various valve areas and/or valves throughout a well network. For example, a system manager (145) may enhance the safety of one or more well operations using a valve panel at a well site that shows various valve areas and their corresponding components. Accordingly, the user interface may present valve data, well operation data, reservoir pressure data or other pressure data regarding valves, and image data to various user devices.

In particular, a system manager (145) may implement different levels of authorization and access using a valve panel for operating different valves. During an operation, for example, a human operator may have the highest level of access to operate G-S smart valves in a well network. However, some well personnel may not have a need to operate G-S smart valves, and may not be granted permission to operate it. Thus, a system manager (145) may implement access levels for different users based on assigned tasks, assigned roles in a well operation or at the well site, and other access criteria. For example, a user may be assigned different time periods for performing different well tasks. During the user's specified time period, the user may operate one or more valves associated with his well tasks, but may not operate the valves outside the specified time period or valves unrelated to such tasks. In some embodiments, a system manager (145) includes functionality for automatically changing access levels for one or more valves. Additionally, the system manager (145) may also disable all restrictions in a well emergency, so that any user may operate any valves in a well network. The permission may also be based on the values of the operational parameters, where the access may be granted or denied when one or more of the operational parameters is not in required range.

In some embodiments, a system manager (145) analyzes one or more user credentials to determine whether to operate one or more G-S smart valves (290). For example, a user device may transmit a request to operate the G-S smart valve (290) with one or more user credentials. The user device may transmit user identification, with or without, a password to the system manager (145). Likewise, a user device may scan a user's ID to obtain user credential for determine access for operating a valve. Furthermore, a user device may be connected to a system manager (145) over a network connection. For example, a user device may transmit user credentials and requests to operate valves over a WiFi connection, thereby allowing a remote activation from the user device. This allows the system manager (145) to determine the operational status of the well (On/Off) remotely. This in turn reflects on the compliance of any given well and accurate reflection of desired operational status in accordance with monthly assigned objectives and targets.

In some embodiments, a system manager (145) communicates with a user directory manager (125) to determine valve access rights within a well system. For example, a user directory manager (125) may include hardware and/or software with functionality to manage permissions and access to network resources within a network. More specifically, the user directory manager may store user information as objects in a database operated by a user directory manager. An object may be a single element, such as a user, group, application or device (e.g., an operator workstation). Moreover, a user directory manager may include a set of processes and services implemented on a local server or a remote server that authenticates users and devices in the network. For example, a user directory manager may be a domain controller that assigns and enforces various security policies for a computer network domain, such as through validating user credentials (e.g., passwords and user identifications, such as login IDs), user types (e.g., a normal user, a system administrator, etc.), and/or privilege levels (e.g., by specifying which control systems may be accessed by a particular user or user device). Once a user directory manager verifies user credentials with respect to a predetermined time period for accessing one or more control systems, the user directory manager may transmit an access confirmation to a system manager. In particular, the access confirmation may be a network message that identifies one or more parameters (e.g., time duration, level of control system privileges, etc.) of a user session for a user and/or user device for accessing one or more control systems.

In some embodiments, the control system (120) includes functionality for determining and/or implementing one or more remediation operations based on valve statuses, and/or valve network data (142). A remediation operation may include replacing a valve component that is part of a valve system based on the valve component failing to satisfy a predetermined criterion (e.g., integrity criteria, operational failure, etc.). Likewise, a remediation operation may also include adjusting production operations to manage the integrity of the valve component. Likewise, a remediation operation may also include applying one or more maintenance operations to prevent future failure. In some embodiments, the control system (120) may automatically prioritize various remediation procedures among different valve components (e.g., limit feedback switches, diverters, pilot valves, solenoid valves, and supply valves) instantaneously based on future plant operations, and/or the integrity states of various production network components.

In some embodiments, the control system (120) may include a system display (138). The system display (138) is configured to display the parameters and status of various systems within the production system (100). The system display (138) may be integrated into the control panel (132). The system display (138) includes hardware equipment and/or software for displaying the parameters and status of various systems.

In some embodiments, the control system (120) may include a user interface (151). The user interface (151) may be integrated with the user device (150) or may be integrated with various components of the control system (120) such as the system display (138). The user device (150) may communicate with the control system (120) to present status reports to a particular user. Based on the status reports, the user device (150) may also manage various commands for performing one or more remediation operations based on one or more user selections. The user device (150) may be a personal computer, a handheld computer device such as a smartphone or personal digital assistant, or a human-machine interface (HMI). For example, a user may interact with the user interface (e.g., a graphical user interface) (151) to inquire regarding valve network status and component integrity data in one or more valve system components at the production plant (105). Through user selections or automation, the control system (120) may identify valve network (e.g., G-S smart valves) (110) that closed unintentionally and implement remediation operations accordingly such as shutting down the production operations.

In one or more embodiments, the production system (100) may include an emergency shutdown system (ESD). The ESD is operatively connected to one or more network valves operatively connected to one or more production flowlines (108). The ESD may be any system capable of stopping the flow of production fluid in a production flowline by closing a valve network (110). The ESD may be controlled manually or automatically. The ESD may include a computer (e.g., the computer system (600) further described in FIG. 6). The ESD may include one or more sensors disposed on the production flowline for measuring parameters such as pressure data, flow rate data, and temperature data. The ESD may monitor pressure differential across the valve network (110). In some embodiments, the ESD is used as a safety mechanism for emergency activation. For example, if the pressure differential across the network valves, pilot valves, or other production system components exceeds a pre-set threshold, the ESD is triggered to stop the flow of a production fluid. In other embodiments, if the measured flow rate surpasses a preset limit, the ESD transmits an alarm. An alarm may alert an operator or user to take corrective action, such as shutting down the production fluid supply.

In some embodiments, an integrity assessment of one or more valve network components is generated by the control system (120) upon obtaining a request from the user device (150) and using various predetermined criteria (e.g., valve network data (142), production data (130), valve status data (136), and/or control fluid data (139)). Valve network data (142) may include feedback signal data and/or component malfunction data (e.g., regulator malfunctions, solenoid valve malfunctions, feedback device malfunctions, diverter malfunctions, and/or supply valve malfunctions). The control system (120) may be configured to detect malfunctions. Detecting malfunctions may include detecting a failure of control fluid flow to one or more network valves. Detecting malfunctions may also include using one or more sensors configured to detect malfunctions of components of the G-S smart valve system. The failure of control fluid flow may include cessation of control fluid flow due to any component of the G-S smart valve system malfunctioning. Detecting malfunctions may also include detecting the closing of one or more network valves. The request may be a network message transmitted between the user device (150) and the control system (120) that identifies a particular valve component, production system (100), or portion of the G-S smart valve system (10) for an operational analysis. In some embodiments, the control system (120) includes functionality for transmitting signals and/or commands to one or more valve networks to implement a particular remediation operation. For example, the control system (120) may transmit a network message over a machine-to-machine protocol to one or more valve networks in the production plant (105). A command may be transmitted periodically, based on user input, or automatically based on changes in production data (130) and/or valve status.

While FIG. 1 shows various configurations of components, other configurations may be used without departing from the scope of the disclosure. For example, various components in FIG. 1 may be combined to create a single component. As another example, the functionality performed by a single component may be performed by two or more components.

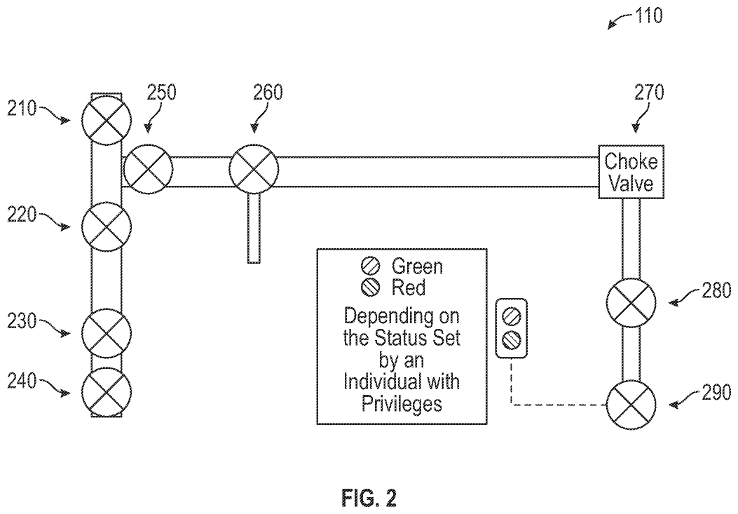

FIG. 2 shows the valve network (110) in accordance with one or more embodiments. The valve network (110) may include one or more network valves operatively connected to one or more production flowlines (108). The valve network and components may be operatively connected to the control system (120). Each production flowline (108) being operatively connected to a valve network (110) may further be operatively connected to various systems within the production system (100) such as production wells, gathering systems, production headers, and/or production plants. The valve network (110) may be configured to stop/start the flow (290) of production fluids within each production flowline (108) or the production system (100).

In one or more embodiments, the valve network (110) includes one or more valve crown valves (210), master valves (220), extra casing valves (230), subsurface safety valves (240), wing valves (250), kill valves (260), choke valves (270), plot limit valves (280), and G-S smart valves (290).

In one or more embodiments, the crown valve (210) is an isolation valve that is installed at the top of the wellhead. The crown valve (210) may be used to provide isolation of the well from the surface facilities. Typically, the crown valve (210) is closed until there is a need to access the well. Specifically, the crown valve (210) may be opened for well interventions, well maintenance, or emergency situations. Further, the crown valve (210) may be connected to the master valve (220). Specifically, the master valve (220) may be positioned below the crown valve (210) and regulate the overall flow of hydrocarbons in the well. When interventions or maintenance are performed, the crown valve (210) is opened first and followed by the controlled operation of the master valve to manage the flow.

In one or more embodiments, the extra casing valve (230) provides additional control of the well by controlling the hydrocarbon flow to isolate the casing string from the wellbore. Further, the subsurface safety valve (240) is typically a hydraulic failsafe close valve located at the surface. The subsurface safety valve (240) is another safety device located below the surface, e.g., several hundred-plus feet below the surface. The subsurface safety valve (240) makes up part of the production tubing and provides an arrangement for safety closure in the case of uncontrolled release of hydrocarbons, such as a kick. Also, the subsurface safety valve (240) may be used as a barrier when testing or needed to perform maintenance on the wellhead. The combination of the extra casing valve (230) and the subsurface safety valve (240) improves the integrity and safety of the well.

The wing valve (250) is mounted on the sides of the wellhead. The wing valve (250) may be used to provide a more localized flow control for specific parts of the wellhead. In the case of needing to enter a well, the wing valve (250) would be closed and the master valve (220) would be open. Additionally, the wing valves (250) may be closed to isolate or control the flow of any other component. Further, the kill valve (260) is used to stop or control the flow of hydrocarbons from the wellbore. The primary use of the kill valve (260) is to manage the pressure in the system and to prevent blowouts.

The choke valve (270) may be positioned in the downstream part of the wellhead. The primary function of the choke valve (270) may be to control the flow of fluids through the production system by controlling the pressure and fluid velocity. Further, the plot limit valve (280) is a valve for testing, maintenance and isolation purposes, such as when the choke valve (270) is being replaced.

In one or more embodiments, the G-S smart valve (290) may be a pneumatically activated actuated valve. The G-S smart valve (290) may be used to at least stop/start the flow of production fluid. The G-S smart valve (290) may include a closed position and an open position. The G-S smart valve (290) may also be configured to have a partially opened position. The G-S smart valve (290) may be configured to communicate a valve status (e.g., opened, closed, or partially opened) with the control system (120). In some embodiments, the G-S smart valve (290) may be configured to be automated.

The G-S smart valve (290) may include hardware equipment for automating the opening and closing. For example, the hardware equipment may include a feedback component (e.g., a limit feedback switch). The feedback component may be configured to actuate the actuator to close or open the valve. The feedback component may be configured to communicate one or more feedback signals (e.g., a limit feedback switch signal) with the control system (120) when the G-S smart valve (290) is opened or closed/closing. The feedback component may be configured to transmit feedback signals to the control system (120). The feedback signal may indicate whether the G-S smart valve (290) is opened or closed/closing. The control system (120) is configured to detect the feedback signal. The control system (120) may be configured to compare the G-S smart valve (290) status with the feedback signal.

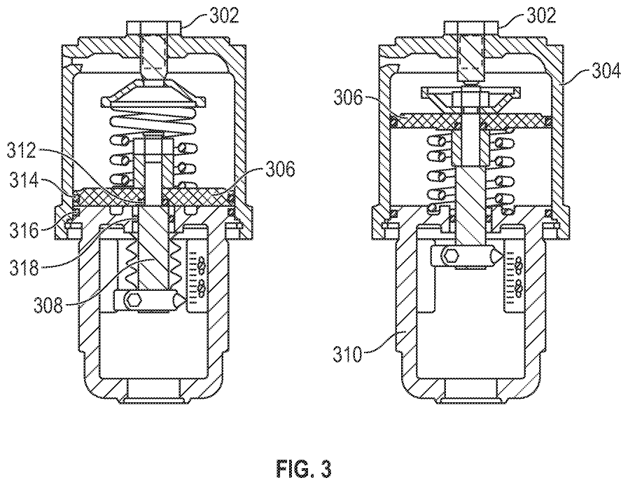

In one or more embodiments, FIG. 3 shows the G-S smart valve schematics. The G-S smart valve (290) may operate using compressed gases. The G-S smart valve (290) may use an adjusting screw (302) to precisely control the flow of the fluids. Additionally, the adjusting screw allows finely tuning the position of the valves. Further, the cylinder (304) may house a piston (306) which converts a pneumatic pressure into a mechanical motion. The piston (306) may be connected to the actuator stem (308) which serves as a driver for opening or closing the valve. The actuator stem (308) may extend from the actuator to the valve body and may transmit the motion generated by the actuator to the valve mechanism. A structural support to the G-S smart valve (290) is provided by the yoke (310) which ensures alignment and stability during the operation.

In one or more embodiments, the sealing components such as a piston stem O-ring (312), a piston O-ring (314), a yoke O-ring (316), and an actuator stem ring (318) maintain the system integrity. Specifically, the stem O-ring (312) prevents fluid leakage around the piston stem and enables efficient and controlled movement within the cylinder. The piston O-ring (314) may form a tight seal between the piston and the cylinder walls and prevent the leakage of the pneumatic pressure. Further, the yoke O-ring (316) and actuator stem ring (318) additionally contribute to airtight connections, preventing leakage along the yoke and actuator stems, respectively.

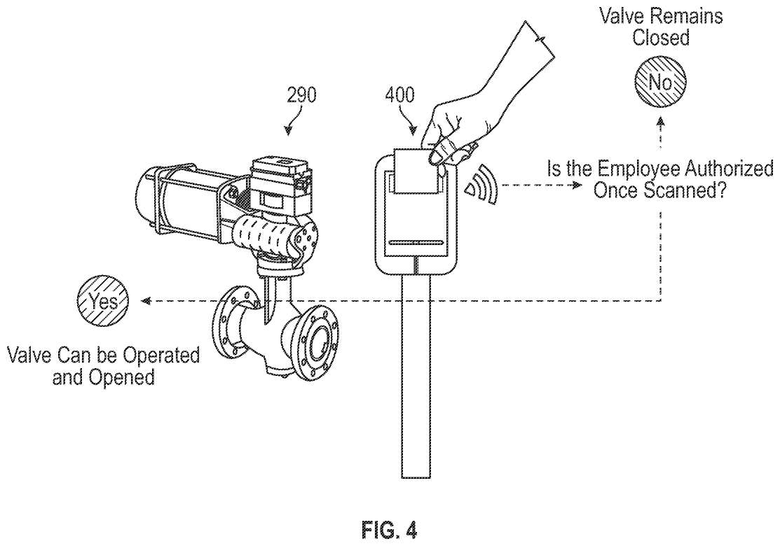

As shown in FIG. 4, the G-S smart valve (290) is integrated with a card scanner (400). The card scanner (400) is connected to the control system (120) and serves as an access control mechanism. For example, the card scanner (400) may be, at least, a proximity card reader, smart card reader, or any other technology with the ability to read and verify the credentials encoded on an access card provided by the operator. Further, the access permissions may be assigned to individual operators or groups and encoded into their access cards. The permissions determine which individuals or groups have the authority to operate the G-S smart valve (290). The permissions may be configured based on roles, responsibilities, or specific tasks related to the G-S smart valve (290). Additionally, the card scanner (400) may be replaced or used in combination with any other authentication mechanism including a user interface for inserting credentials to access the G-S smart valve (290).

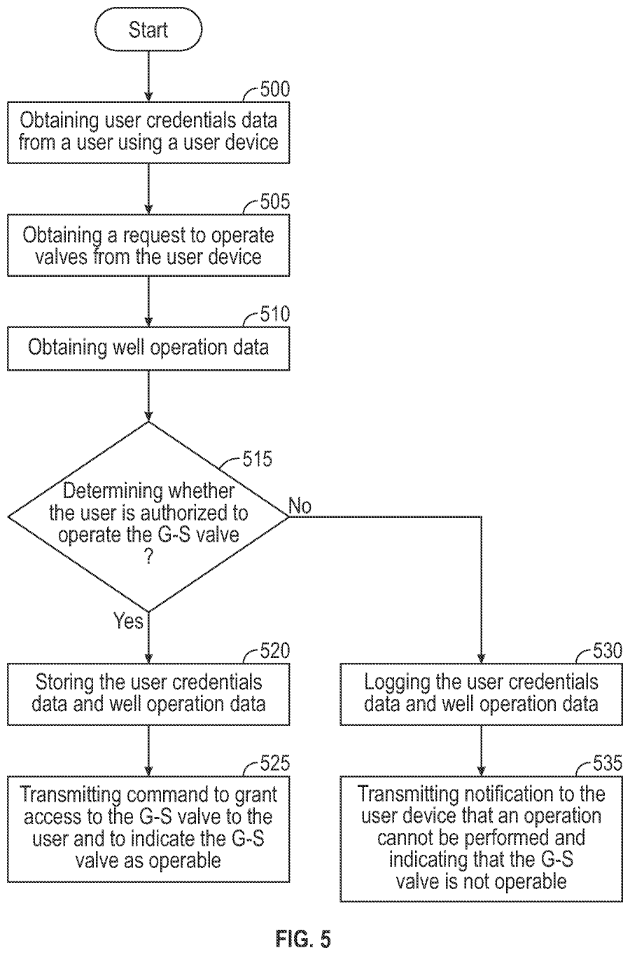

Turning to FIG. 5, FIG. 5 shows a flowchart in accordance with one or more embodiments. Specifically, FIG. 5 describes a general method for managing a valve system in accordance with one or more embodiments. One or more blocks in FIG. 5 may be performed by one or more components (e.g., the control system (120)) as described in FIGS. 1-4. While the various blocks in FIG. 5 are presented and described sequentially, one of ordinary skill in the art will appreciate that some or all of the blocks may be executed in different orders, may be combined or omitted, and some or all of the blocks may be executed in parallel. Furthermore, the blocks may be performed actively or passively.

In Block 500, one or more user credentials are obtained regarding a user associated with a user device in accordance with one or more embodiments. In particular, a control system may only allow authorized users to access G-S smart valve (290) or G-S smart valve data. Authorization may be based on static user rights (e.g., a user X may have access to change valve states for valves A, D, and F, but not valves B, C, or E). In some embodiments, authorization may be associated with an ongoing well operation. For example, once an operation is initiated, certain users may be assigned access rights to various G-S smart valves (290), while all other users may be denied access privileges. Once the operation ends, access rights may be returned to users based on their regular privileges. In some embodiments, a control system communicates with a user directory manager to determine what level of authorization is associated with a user or user device.

In Block 505, a request is obtained from a user device to operate one or more G-S smart valves (290) at a well in accordance with one or more embodiments. For example, a user may transmit a request using a personal identification card and a card scanner. Additionally in response to a user input in a user device. The request may be a network message transmitted between a user device and a control system that identifies a desire for a user session to access G-S smart valve data for one or more valves in a well system. On the other hand, a request may also be a network message specific to one or more G-S smart valves (290), which may include an instruction to adjust one or more current G-S smart valve states. For example, a request may be a message from a user to open valve A and close valve B.

In Block 510, well operation data are obtained for a well in accordance with one or more embodiments. For example, a control system may receive information from control systems regarding ongoing well operations. Likewise, the well operation data may also be provided by one or more user devices (e.g., a user device may transmit a signal to a control system that an operation has been initiated).

In Block 515, a determination is made whether a user is associated with a user device authorized to operate one or more G-S smart valves (290) in accordance with one or more embodiments. For example, a control system may analyze whether access rights are associated with a particular user based on the user access credentials. Where a determination is made that a user or user device is authorized to operate one or more G-S smart valves (290), the process may proceed to Block 520. Where a determination is made that the user or the user device is not authorized to operate one or more G-S smart valves (290), the process may proceed to Block 530.

In one or more embodiments, a system manager overseeing a G-S smart valve (290) has the capability to establish varying levels of authorization and access through a valve panel, allowing the operation of different valves. For instance, during an operation, the operator managing the operation may be granted the highest level of access to operate any valves within the well network, including the G-S smart valve (290). However, certain personnel associated with the well may be required to operate valves for well equipment on the surface or for tasks unrelated to the ongoing operation. Consequently, the system manager can implement distinct access levels for the operators based on their assigned tasks, roles in well operations or at the well site, and other specified access criteria. For example, the operator might be allotted specific time periods for performing various well-related tasks. Within these designated time periods, the user has the authority to operate one or more valves linked to their assigned tasks but is restricted from operating valves outside the specified timeframe or unrelated to their tasks. In certain implementations, the system manager incorporates functionality to automatically adjust access levels for one or more valves. During an emergency, the manager may limit access to all valves except for the operator. Conversely, in a well emergency, the system manager might deactivate all restrictions, permitting any user to operate any valves within the well network.

In Block 520, the user credentials data and well operation data are stored in the control system (120). Storing the well operation data ensures that all wells in the area are fully controlled in terms of production and injection. That ensures that the wells are meeting the predetermined targets for any given time period. Additionally, the well's targets are predetermined by reservoir engineers based on an analysis of the reservoir of any given well and its associated characteristics. The analysis-based forecast may be negatively affected when there is no control of the well's status, resulting in wasting reservoir engineering assets and jeopardizing the well's overall performance. Further, when the well is opened or closed through the G-S smart valve (290), production engineers can view the operational status of the well and confirm whether the well is producing and/or injecting. Additionally, access to the log of the stored user credentials that were affiliated with the well's opening or closing enables production engineers to accurately determine the operating status of a given well in a remote manner.

In Block 525, valve data are presented on a user device in accordance with one or more embodiments. For example, a graphical panel may be provided that enables visualization of various G-S smart valve (290) positions, pressure gauge readings, and other relevant data, such as the safety conditions at various G-S smart valve (290) areas and ongoing well operations. The valve data may also present images of various G-S smart valve (290) areas based on image data collected by a control system. Presenting the data on the user device permits accurately determining the operational status of the well (On/Off) remotely and reflects on the compliance of any given well and accurate reflection of desired operational status in accordance with monthly assigned objectives and targets.

Additionally, one or more commands are transmitted to G-S smart valve (290) in accordance with one or more embodiments. After determining that no technical issues exist with changing a valve state and that the requesting operator has authorization to operate the G-S smart valve (290), a requested valve operation may be performed using one or more commands. For example, a control system may transmit a command to a control system to operate a particular valve and indicate that the particular G-S smart valve (290) is operable. The indication may be in the form of a green light.

In Block 530, the user credentials data and well operation data are stored in the control system (120). Storing the well operation data ensures that a potential technical issue with the well or the valves is recorded and reported to the system manager. Additionally, the user credentials data are stored to ensure the integrity of the well and to stop a potential malicious use of the system by unauthorized users.

In Block 535, when the operator is not authorized to operate the G-S smart valve (290) or when there is a technical issue preventing normal operation of the G-S smart valve (290), a notification is transmitted to a user device that an operation cannot be performed on G-S smart valve (290) in accordance with one or more embodiments. For example, a notification may be presented in a user device that a specific user lacks authorization privileges to access a GUI provided by a control system or lacks authorization to adjust valve states for one or more valves. Likewise, the notification may also describe conditions regarding a valve that prevents access, e.g., a particular valve is associated with ongoing operations, which prevents access to the user device at the present time. The indication may be in the form of a red light.

An example of the computer system (600) is described with reference to FIG. 6, in accordance with one or more embodiments. FIG. 6 is a block diagram of a computer system (600) used to provide computational functionalities associated with described algorithms, methods, functions, processes, flows, and procedures as described in the instant disclosure, according to an implementation. The illustrated computer (602) in the computer system (600) is intended to encompass any computing device such as a server, desktop computer, laptop/notebook computer, wireless data port, smartphone, personal data assistant (PDA), tablet computing device, one or more processors within these devices, or any other suitable processing device, including both physical or virtual instances (or both) of the computing device. Additionally, the computer (602) may include an input device, such as a keypad, keyboard, touch screen, or other device that can accept user information, and an output device that conveys information associated with the operation of the computer (602), including digital data, visual, or audio information (or a combination of information), or a GUI.

The computer (602) can serve in a role as a client, network component, server, database or other persistency, or any other component (or a combination of roles) of the computer system (600) for performing the subject matter described in the instant disclosure. The illustrated computer (602) is communicably coupled with a network (630). In some implementations, one or more components of the computer (602) may be configured to operate within environments, including cloud-computing-based, local, global, or other environment (or a combination of environments).

At a high level, the computer (602) is an electronic computing device operable to receive, transmit, process, store, or manage data and information associated with the described subject matter. According to some implementations, the computer (602) may also include or be communicably coupled with an application server, e-mail server, web server, caching server, streaming data server, business intelligence (BI) server, or other server (or a combination of servers).

The computer (602) can receive requests over a network (630) from a client application (for example, executing on another computer (602)) and responding to the received requests by processing the said requests in an appropriate software application. In addition, requests may also be sent to the computer (602) from internal users (for example, from a command console or by other appropriate access method), external or third-parties, other automated applications, as well as any other appropriate entities, individuals, systems, or computers.

Each of the components of the computer (602) can communicate using a system bus (603). In some implementations, any, or all of the components of the computer (602), both hardware or software (or a combination of hardware and software), may interface with each other or the interface (604) (or a combination of both) over the system bus (603) using an application programming interface (API) (612) or a service layer (613) (or a combination of the API (612) and service layer (613)). The API (612) may include specifications for routines, data structures, and object classes. The API (612) may be either computer-language independent or dependent and refer to a complete interface, a single function, or even a set of APIs. The service layer (613) provides software services to the computer (602) or other components (whether or not illustrated) that are communicably coupled to the computer (602). The functionality of the computer (602) may be accessible for all service consumers using this service layer (613). Software services, such as those provided by the service layer (613), provide reusable, defined business functionalities through a defined interface. For example, the interface may be software written in JAVA, C++, Python, or other suitable language providing data in extensible markup language (XML) format or another suitable format. While illustrated as an integrated component of the computer (602), alternative implementations may illustrate the API (612) or the service layer (613) as stand-alone components in relation to other components of the computer (602) or other components (whether or not illustrated) that are communicably coupled to the computer (602). Moreover, any or all parts of the API (612) or the service layer (613) may be implemented as child or sub-modules of another software module, enterprise application, or hardware module without departing from the scope of this disclosure.

The computer (602) includes an interface (604). Although illustrated as a single interface (604) in FIG. 6, two or more interfaces (604) may be used according to particular needs, desires, or particular implementations of the computer (602). The interface (604) is used by the computer (602) for communicating with other systems in a distributed environment that may be connected to the network (630). Generally, the interface (604) includes logic encoded in software or hardware (or a combination of software and hardware) and operable to communicate with the network (630). More specifically, the interface (604) may include software supporting one or more communication protocols associated with communications such that the network (630) or interface's hardware is operable to communicate physical signals within and outside of the illustrated computer (602).

The computer (602) includes at least one computer processor (605). Although illustrated as a single computer processor (605) in FIG. 6, two or more processors may be used according to particular needs, desires, or particular implementations of the computer (602). Generally, the computer processor (605) executes instructions and manipulates data to perform the operations of the computer (602) and any algorithms, methods, functions, processes, flows, and procedures as described in the instant disclosure.

The computer (602) also includes a memory (606) that holds data for the computer (602) or other components (or a combination of both) that may be connected to the network (630). For example, memory (606) can be a database storing data consistent with this disclosure. In one example, memory (606) may store programs or algorithms for controlling operation of the control system (120) or the operation of the one or more valve networks described above in accordance with one or more embodiments with reference to FIGS. 1-3. For example, the programs or algorithms may control operation of the valve networks described with reference to FIG. 2. Although illustrated as a single memory (606) in FIG. 6, two or more memories may be used according to particular needs, desires, or particular implementations of the computer (602) and the described functionality. While memory (606) is illustrated as an integral component of the computer (602), in alternative implementations, memory (606) can be external to the computer (602).

The application (607) is an algorithmic software engine providing functionality according to particular needs, desires, or particular implementations of the computer (602), particularly with respect to functionality described in this disclosure. For example, the application (607) can serve as one or more components, modules, applications, etc. In one example, the application (607) may include programs or algorithms for controlling operation of the control system (120) or each of the valve networks described above in accordance with one or more embodiments with reference to FIGS. 1-3. For example, the programs or algorithms may control operation of control systems described with reference to FIG. 1 in accordance with one or more embodiments. Further, although illustrated as a single application (607), the application (607) may be implemented as multiple applications (607) on the computer (602). In addition, although illustrated as integral to the computer (602), in alternative implementations, the application (607) can be external to the computer (602). In one example, the method described with reference to FIG. 6 may be implemented by the application (607).

There may be any number of computers (602) associated with, or external to, the computer system (600) containing computer (602), each computer (602) communicating over network (630). Further, the term “client,” “user,” and other appropriate terminology may be used interchangeably as appropriate without departing from the scope of this disclosure. Moreover, this disclosure contemplates that many users may use one computer (602), or that one user may use multiple computers (602). Furthermore, in one or more embodiments, the computer (602) is a non-transitory computer readable medium (CRM).

Embodiments of the present disclosure may provide at least one of the following advantages. The present invention includes allowing, using the control system (120), to control G-S smart valve (290) based on operating parameters and user authorization. The operating parameters may include a flow rate, a pressure, a temperature, a valve position, and a leak detection. Specifically, access to the G-S smart valve (290) may be based on a value of a certain operating parameter. The closing of the G-S smart valve (290) may include stopping production flow causing loss of production. The loss of production may cause a loss of revenue. The stopping and the restarting of production flow may result in stress being placed on the production system (100) causing equipment failure.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

What is claimed:

1. A method, comprising:
obtaining, by a system manager and from a first system device, a first request to operate a first go-stop (G-S) smart valve in a well by a first user, wherein the first request is transmitted to the system manager in response to a user input of a first user credential to the first system device;
determining, by the system manager, that the first user associated with the first user credential is authorized to operate the first G-S smart valve at the well;
transmitting, by the system manager, a command to the first G-S smart valve, wherein the command grants authorization to the first user to operate the first G-S smart valve;
indicating, using the system manager, an operational status of the first G-S smart valve based on the determination; and
controlling, using the system manager, an access to the well based on the operational status of the first G-S smart valve.

2. The method of claim 1, further comprising:
obtaining, by the system manager and from a second system device, a second request to operate a second G-S smart valve in the well;
obtaining a second user credential for a second user, wherein the second user credential is transmitted to the system manager with the second request;
determining, by the system manager, whether the second user is authorized to operate the second G-S smart valve;
transmitting, to the second G-S smart valve, a notification that the second user cannot operate the second G-S smart valve in response to determining that the second user is not authorized;
indicating, using the system manager, that the first G-S smart valve is not operable based on the determination;
controlling, using the system manager, the access to the well based on the operational status of the second G-S smart valve.

3. The method of claim 1,
wherein the determination is based on the first user credentials and a plurality of operating parameters.

4. The method of claim 1,
wherein the command grants authorization to the first user to open and close the first G-S smart valve.

5. The method of claim 2,
wherein the first G-S smart valve and the second G-S smart valve are pneumatically controlled valves.

6. The method of claim 1,
wherein the first system device is a card scanner, and
wherein the first user credential is card scan information.

7. The method of claim 3,
wherein the first G-S smart valve obtains the plurality of operating parameters, and
wherein the plurality of operating parameters includes a flow rate, a pressure, a temperature, a valve position, and a leak detection.

8. The method of claim 1,
wherein the operational status of the first G-S smart valve is indicated by a visual go command and a visual stop command, and
wherein the operational status of the first G-S smart valve is indicated by a digital go command and a digital stop command.

9. A system, comprising:
a plurality of control systems at a well comprising a wellbore;
a first system device; and
a system manager comprising a computer processor and coupled to the plurality of control systems and the first system device, wherein the system manager comprises functionality for:
obtaining, from the first system device, a first request to operate a first go-stop (G-S) smart valve in the well by a first user, wherein the first request is transmitted to the system manager in response to a user input of a first user credential to the first system device;
determining that the first user associated with the first user credential is authorized to operate the first G-S smart valve at the well;
transmitting a command to the first G-S smart valve, wherein the command grants authorization to the first user to operate the first G-S smart valve; and
indicating an operational status of the first G-S smart valve based on the determination; and
controlling an access to the well based on the operational status of the first G-S smart valve.

10. The system of claim 9,
wherein the system manager is disposed at a cloud server outside a well site comprising a wellbore.

11. The system of claim 9, further comprising:
a user credentials manager coupled to the system manager,
wherein the system manager further comprises functionality for:
obtaining, from a second system device, a second request to operate a second G-S smart valve in the well;
obtaining a second user credential for a second user, wherein the second user credential is transmitted to the system manager with the second request;
determining whether the second user is authorized to operate the second G-S smart valve;
transmitting, to the second G-S smart valve, a notification that the second user cannot operate the second G-S smart valve in response to determining that the second user is not authorized;
indicating that the second G-S smart valve is not operable based on the determination; and
controlling an access to the well based on the operational status of the second G-S smart valve.

12. The system of claim 9,
wherein the determination is based on the first user credentials and a plurality of operating parameters.

13. The system of claim 9,
wherein the command grants authorization to the first user to open, close, and adjust the first G-S smart valve.

14. The system of claim 11,
wherein the first G-S smart valve and the second G-S smart valve are pneumatically controlled valves.

15. The system of claim 9,
wherein the first system device is a card scanner, and
wherein the first user credential is card scan information.

16. The system of claim 12,
wherein the first G-S smart valve obtains the plurality of operating parameters,
wherein the plurality of operating parameters includes a flow rate, a pressure, a temperature, a valve position, and a leak detection.

17. The system of claim 9,
wherein the operational status of the first G-S smart valve is indicated by a go command and a stop command.

18. A non-transitory computer readable medium storing instructions executable by a computer processor, the instructions comprising functionality for:
obtaining, from a first system device, a first request to operate a first go-stop (G-S) smart valve in a well by a first user, wherein the first request is transmitted to a system manager in response to a user input of a first user credential to the first system device;
determining that the first user associated with the first user credential is authorized to operate the first G-S smart valve at the well;
transmitting a command to the first G-S smart valve, wherein the command grants authorization to the first user to operate the first G-S smart valve; and
indicating that the first G-S smart valve is operable based on the determination.

19. The non-transitory computer readable medium of claim 18, wherein the instructions further comprise functionality for:
obtaining, from a second system device, a second request to operate a second G-S smart valve in the well;
obtaining a second user credential for a second user, wherein the second user credential is transmitted to the system manager with the second request;
determining whether the second user associated is authorized to operate the second G-S smart valve; and
transmitting, to the second G-S smart valve, a notification that the second user cannot operate the second G-S smart valve in response to determining that the second user is not authorized,
indicating that the first G-S smart valve is not operable based on the determination.

20. The non-transitory computer readable medium of claim 18,
wherein the determination is based on the first user credentials and a plurality of operating parameters.
